(19) United States
(12) Patent Application Publication
(10) Pub. No.: US 2022/0188157 A1
(43) Pub. Date: Jun. 16, 2022

(54) METHOD AND SYSTEMS FOR EXECUTING TASKS IN IOT ENVIRONMENT USING ARTIFICIAL-INTELLIGENCE (AI) TECHNIQUES

(71) Applicant: Samsung Electronics Co., Ltd., Suwon-si (KR)

(72) Inventors: Rajat SHARMA, Bangalore (IN); Rahul KUMAR, Bangalore (IN); Sourabh TIWARI, Bangalore (IN)

(21) Appl. No.: 17/643,704

(22) Filed: Dec. 10, 2021

(30) Foreign Application Priority Data
Dec. 14, 2020 (IN) 202041054353

(51) Int. Cl. G06F 9/48; G06F 11/30; G06F 11/34; G10L 15/22

(52) U.S. Cl. CPC G06F 9/4881; G06F 9/4818; G10L 2015/223; G06F 11/3438; G10L 15/22; G06F 11/3051

(57) ABSTRACT

The present disclosure provide a method for executing tasks in an IoT environment using artificial-intelligence (AI) techniques. The method comprises: receiving at least one current task related to a user; identifying, based on a pre-defined criteria, a type of the at least one current task and a priority-level of the at least one current task from the at least one current task; generating based on an AI-model, a correlation of one or more of a user-location, a device-usage history pertaining to the user, a list of current active devices with respect to the user, and a user-preference within the IoT environment; and identifying at least one device for communicating a task execution status based on the correlation and based on at least one of the type of the at least one current task and the priority-level of the at least one current task.

### CROSS-REFERENCE TO RELATED APPLICATION

This application is based on and claims priority under 35 U.S.C. 119 to Indian Patent Application No. 202041054353 on Dec. 14, 2020, in the Indian Intellectual Property Office, the disclosures of which are herein incorporated by reference in its entirety.

### BACKGROUND

### 1. Field

The present disclosure relates to an IoT environment and in-particular relates to the utilization of AI in the IoT environment.

### 2. Description of Related Art

Digital appliances like smart-fridges, smart TV, smart speaker etc. may use a voice personal assistant (VPA) to interact with the user and answer their commands. For the assigned task, VPA devices may respond the user via a voice generated by a text to speech (TTS) generation system.

Currently, a state of the art VPA device may not consider whether the user has heard the response. Also, there may be cases where additional user's response and instructions are needed in the middle of the task for further work like baking cake in microwave oven. This often may lead to confusion when the user does not hear the response from the VPA device. For example, the VPA device may have provided the response to user, while the user may consider that the VPA device is still working on the task.

More specifically, as the user assigns task to any VPA device, the VPA device may provide, after completing the task, the response to the user and ends the task without actually considering whether user has heard the response. This may lead to a situation where the user is not able to hear the response due to being absent from the vicinity of the VPA device or for being busy in miscellaneous tasks. The user may keep awaiting a response from the VPA device without even knowing that the task has been completed, which at least may reduce the confidence of the user and reliability on the VPA device for important tasks.

In an example scenario 1, the user may instruct a VPA device “Let me know when the baby wakes up”. The user may have two smart devices, for example a speaker and a mobile phone. Both devices may be connected through cloud/edge computing. When the baby wakes up, the VPA device provides the response “Baby has woken up” to at least one of the two smart devices, the speaker and the mobile phone. The user is not in the proximity of the smart device receiving the response from the VPA device. As the user is not nearby, the user misses the response. The VPA device provides the response without any consideration of a type of device but rather sends the response without considering a proximity of the user.

In other example scenario 2, the user is at home washing clothes through a washing machine. The user inserts the clothes in the washing machine and goes to another room to watch TV. The washing machine encounters some error. The washing-machine starts beeping, and indicates that there is some problem by showing an error code on-screen while the user is not nearby the machine. The User comes after two hours hoping to see all work done, however gets disappointed. Overall, since the user was nearby the washing machine and missed the response. The user would have liked to receive the response from the nearest device such as a TV, so that the error could be fixed. In a nutshell, the VPA device responds without any consideration of a type of a device and a location of a user.

There lies a need of a VPA device that may facilitate response communication to the user in various possible scenarios.

Specifically, there lies a need to have a facility of selecting best scenario among possible scenarios.

### SUMMARY

This summary is provided to introduce a selection of concepts in a simplified format that is further described in the detailed description of the present disclosure. This summary is not intended to identify key or essential inventive concepts of the claimed subject matter, nor is it intended for determining the scope of the claimed subject matter.

The present disclosure refers a method for executing tasks in an IoT environment using artificial-intelligence (AI) techniques. The method comprises: receiving at least one current task related to a user; identifying, based on a pre-defined criteria, a type associated with the at least one current task and a priority-level associated with the at least one current task from the at least one current task; generating. based on an AI-model, a correlation of at least one of a user-location, a device-usage history pertaining to the user, a list of current active devices with respect to the user, and a user-preference within the IoT environment; and identifying at least one device for communicating a task-execution status based on the correlation and based on at least one of the type of the at least one current task or the priority-level of the at least one current task.

The present disclosure refers a method for executing tasks in an IoT environment using artificial-intelligence (AI) techniques, comprising: receiving at least one current task related to a user; identifying, based on a pre-defined criteria, a type of the at least one current task and a priority-level associated with the at least one current task from the at least one current task; generating based on an AI-model, a correlation of at least one of a user-location, a device-usage history, a device current operational status and a user-preference within the IoT environment; identifying a list of modes for communicating a task-execution status based on at least one of the correlation based on at least one of the type of the at least one current task or the priority-level of the at least one current task; providing the task-execution status on a first device associated with the one or modes within the list of modes; detecting a non-acknowledgement from the user in respect of the task execution status provided from the first device for a predefined time duration; and providing the task execution status on a second device associated with the one or modes within the list of modes after the predefined time duration.

To further clarify the advantages and features of the present disclosure, a more particular description of the present disclosure will be rendered by reference to specific embodiments thereof, which is illustrated in the appended drawings. It is appreciated that these drawings depict only typical embodiments of the present disclosure and are therefore not to be considered limiting of its scope. The present disclosure will be described and explained with additional specificity and detail with the accompanying drawings.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 illustrates a method for executing tasks in an IoT environment using artificial-intelligence (AI) techniques in accordance with the embodiment of the present disclosure;

FIG. 2 illustrates a method for executing tasks in an IoT environment using artificial-intelligence (AI) techniques in accordance with another embodiment of the present disclosure;

FIG. 3 illustrates the process of task generation in accordance with another embodiment of the present disclosure;

FIG. 4 illustrates a structure of a task generator performing the process of FIG. 3 in accordance with an embodiment of the present disclosure;

FIG. 5 illustrates the process of task validation in accordance with another embodiment of the present disclosure;

FIG. 6 illustrates a structure of a device and a notification scheduler in accordance with an embodiment of the present disclosure;

FIG. 7 illustrates an extended structure of FIG. 6 comprising the device and the notification scheduler, a task termination flag generator, and an event notification with a back-off timer in accordance with an embodiment of the present disclosure;

FIG. 8 illustrates an extended structure of FIG. 7 comprising an acknowledgement detector in accordance with another embodiment of the present disclosure;

FIG. 9 illustrates a list of IOT devices in accordance with another embodiment of the present disclosure;

FIG. 10 illustrate a procedure for location detection of a user and event notification with help of a remote server service in accordance with another embodiment of the present disclosure; and

FIG. 11 illustrates a typical hardware configuration of the system, in the form of a computer-system, in accordance with another embodiment of the present disclosure.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION

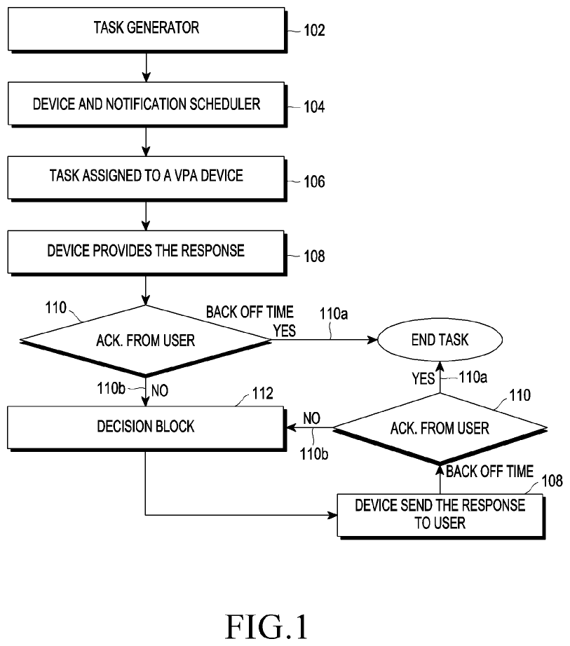

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

For the purpose of promoting an understanding of the principles of the present disclosure, reference will now be made to the embodiment illustrated in the drawings and specific language will be used to describe the same. It will nevertheless be understood that no limitation of the scope of the present disclosure is thereby intended, such alterations and further modifications in the illustrated system, and such further applications of the principles of the present disclosure as illustrated therein being contemplated as would normally occur to one skilled in the art to which the present disclosure relates.

It will be understood by those skilled in the art that the foregoing general description and the following detailed description are explanatory of the present disclosure and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skilled in the art to which this disclosure belongs. The system, methods, and examples provided herein are illustrative only and not intended to be limiting.

FIG. 1 illustrates a method for executing tasks in an IoT environment using artificial-intelligence (AI) techniques in accordance with the embodiment of the present disclosure.

Referring to FIG. 1, Step 102 may correspond to task generation and/or task validation by a task generator based on receiving at least one current task related to a user. An identifying of the at least one received current task may include classifying the at least one current task using pre-defined criteria into at least one of a type of the at least one current task and a priority level of the at least one current task. A repository of the at least one classified current task may be created to enable the identification of the at least one current task. In an example, the type of the at least one current task may be defined by one or more of an instant term, a short term, a long term, a continuous term, and an overlapping term. However, the present disclosure may be construed to cover other forms of tasks as well.

The priority-level of the at least one current task may be related to a time-duration of awaiting user-acknowledgment post communication of the task execution status. The relation may be defined by one or more of short time duration with one or more of a critical level, a high level, a mid-size time duration with a high level. The priority-level of the at least one current task may also aid decision making executed by the task termination flag generator, so that for higher priority tasks, the flag may remain false for a long time. The priority-level of the at least one current task may facilitate sending acknowledgement to user at-least based on:

a) the time duration for which VPA device will wait can be short if priority is critical. The VPA device can retry sooner to acknowledge user, and

b) the number of devices by which a user can be informed, like for critical priority such as accidents, family members of the user can be notified together, instead of one at a time.

The type of the at least one current task may be mapped with the priority-level of the at least one current task, for example, a long term task may relate to a critical level or a high level, a short term task and/or instant task may relate to one or more of a high level or a normal level, and a continuous and overlapping task may relate to a high level or a normal level.

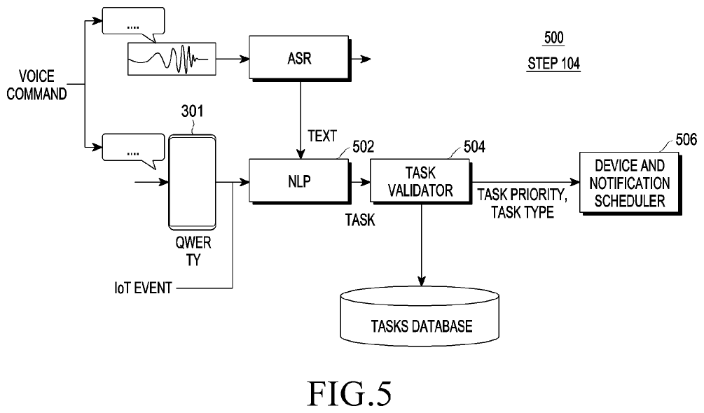

In case of a fire alarm based task generation, a user may say to a VPA (e.g. Bixby) to let him know when there is a fire alarm. The VPA may send the information to the scheduler (e.g. device and notification scheduler 506 in FIG. 5).

Step 104 may correspond to the device and notification scheduler and may relate to identifying, from the at least one received current task, the type associated with the at least one current task and the priority-level associated with the at least one current task, based on the pre-defined criteria as explained in step 102. In case of a fire alarm based task as a part of task classifier result, the fire alarm based task is classified as a long term task. As a task priority classifier result, the fire alarm based task may be recorded as a highest priority task and a user acknowledgement may be required. A task database may record a fire alarm event wherein the detection and information to user may be recorded as a highest priority.

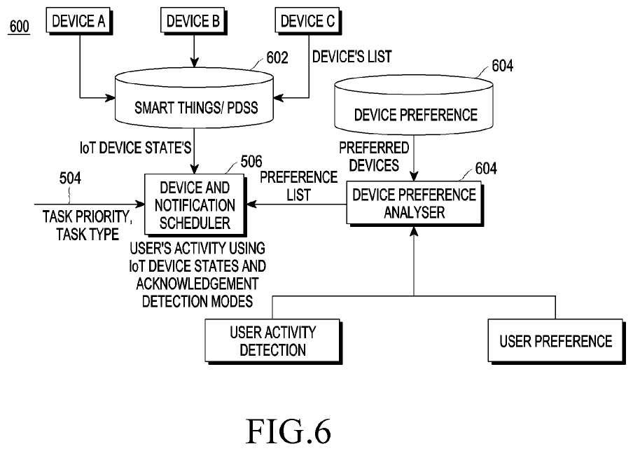

Step 106 may correspond to an assignment of the at least one current task to a VPA device and may include an AI-model (i.e. a device preference analyser 606 in FIG. 6) for generating a correlation of one or more of a user-location, a device-usage history pertaining to the user, a list of current active devices with respect to the user, and a user-preference within the IoT environment.

In an implementation, the correlation of the device-usage history is based on the computation of a device preference through capturing in real-time a user-interaction and activity concerning the device. The correlation of one or more of the user-location, the list of current active devices with respect to the user, and the user-preference comprises capturing one or more of: a user preference submitted with respect to a particular device, a current user activity detection through device-usage, and a preference of the user computed towards a particular device computed post task completion. In an example, the VPA assigns the task to at least one VPA device such as a speaker, a mobile phone, a wearable device etc., for checking the device priority and task category.

Step 108 may relate to the VPA device providing the response. The present step may relate to identifying at least one VPA device for communicating a task-execution status based on one or more of the correlations based on at least one of the types of the at least one current task or the priority-level of the at least one current task. The identification of the at least one VPA device is further based on one or more of the parameters: a user location, a device-usage history, a device current operational status, and a user-preference. The identifying of the at least one VPA device for communicating the task-execution status may be performed by the device and notification scheduler based on ascertaining task-termination flag in active or non-active state and thereupon determining a pendency of acknowledgment from the user. When the flag is false then acknowledgement may be sent. The task execution status is communicated as a task notification based upon ascertaining the state, said communication being enabled through selecting a communication mode. In an example, VPA device such as a Lux device may provide the response “Fire Fire” when fire alarm goes off.

Step 110 may correspond to receipt of acknowledgment or not from a user. In case of receipt of acknowledgment, the condition 110a may occur and the process may end. In an example, the user may give an acknowledgement on the VPA device, for example, a wearable device using touch mode, and the wearable device may send the information of task completion.

Else in case of non-receipt and in case a back-off time related to the current device expires, condition 110b may occur and the control may transfer to step 112. More specifically, upon detecting a non-acknowledgement from the user in respect of the task execution status provided from the VPA device for a predefined time duration, the condition 110b may occurs. For example, the user may not send an acknowledgement with any mode till a back off time (10 sec), VPA may send the information to device notification scheduler as a part of the condition 110b.

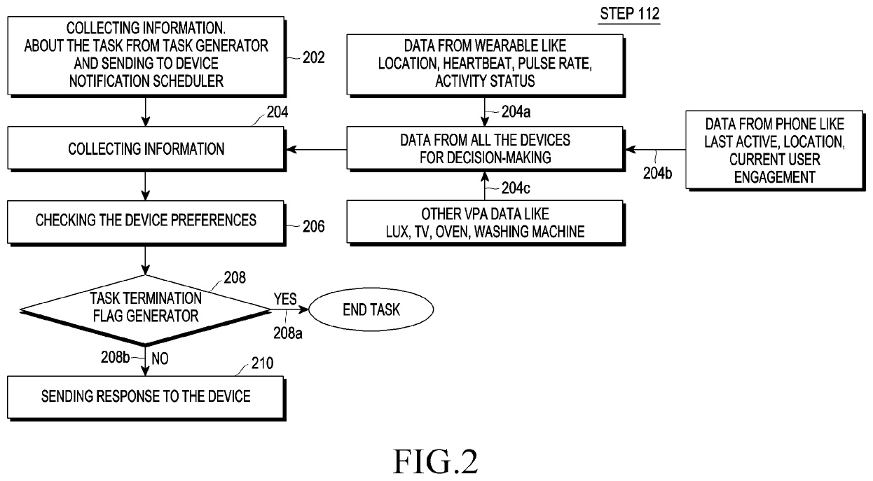

Step 112 may correspond to optionally repeating said communication of the task execution status periodically and has been further explained in FIG. 2. Such repeated communication may be resorted through a different mode of the communication and thereafter steps 108 and 110 may repeat to communicate the task execution status through the newly identified VPA device as per step 112. In an example, the step 112 may correspond to a decision for shortlisting a new VPA device for providing the task execution status from the generated-list after the predefined time duration.

FIG. 2 illustrates a method for executing tasks in an IoT environment using artificial-intelligence (AI) techniques in accordance with another embodiment of the present disclosure.

Referring to FIG. 2, step 202 may correspond to collecting information about the at least one current task from the task generator and sending to the device notification scheduler, and thereby corresponds to step 102 of FIG. 1.

Step 204 may correspond to identifying a list of modes for communicating a task-execution status based on one or more of the correlations based on at least one of the types of the at least one current task or the priority-level of the at least one current task. The same is at least based on collecting information or data from at least one VPA device. For example, data from all he VPA devices for decision making is captured such as a) data from a wearable device like a location, a heartbeat, a pulse rate, and an activity status, b) data from mobile phone like a last active, a location, and a current user engagement, and c) other data from a lux, a TV, an oven, and a washing machine.

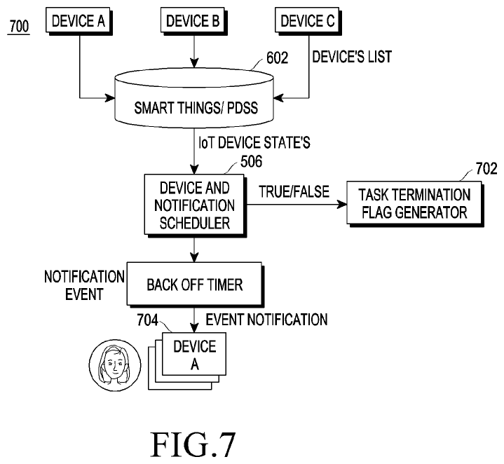

Step 206 may correspond to checking the device preferences as further explained in the description of FIG. 5, FIG. 6, and FIG. 7. Accordingly, based on the data collected in step 204 and the device preferences, a new VPA device may be chosen (as compared to the VPA device chosen in step 108 of FIG. 1) to communicate the task execution status. In an example, the VPA may check the device info from smart things and gets the device-preference. For example, when notification is executed on a mobile phone, the VPA may select the wearable device and may check the task termination flag.

Step 208 may correspond to ascertaining a task termination flag as active or inactive as further explained in the description of FIG. 5, FIG. 6 and FIG. 7. In case that the flag is inactive, the process may end. In case that the flag is set active, then control may transfer to step 210. In case that the flag is false, the VPA may send the notification to the user through VPA device.

Step 210 may relate to VPA device providing the response. At step 210, the new VPA device as shortlisted in step 206 may be permitted for communicating the task execution status and the control-flow may shift back to step 108 of FIG. 1.

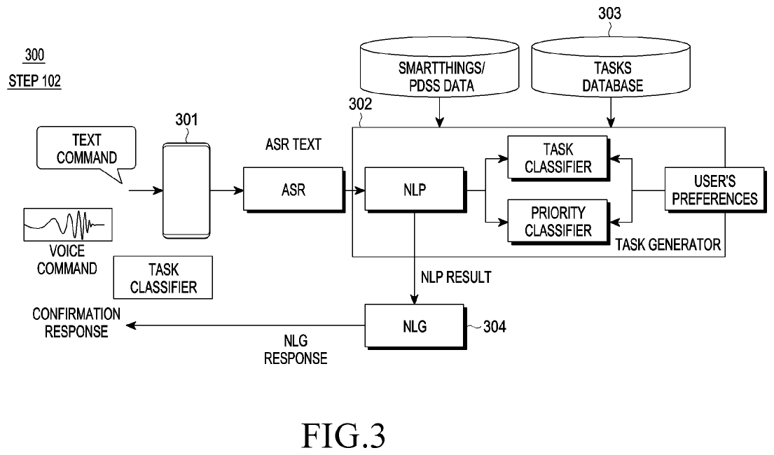

FIG. 3 illustrates the process of task generation in accordance with another embodiment of the present disclosure. FIG. 3 may correspond to step 102 of FIG. 1.

Referring to FIG. 3, based on at least one of a voice command of the user, a text command or an event based trigger, a natural language processing (NLP) system 301 may generate at least one task. A task generator 302 may provide application programming interfaces (API's) to add, update and delete the at least one generated task. The priority and type of the at least one generated task may be updated by the voice command, the text command, or the touch-command. The priority and the type of the at least one generated task may help in deciding notification-attempts and a back-off time duration. A confirmation of the at least one generated task is sent to the user through a natural language generator 304.

A task database or a task DB 303 may have all the tasks that user has created. As an example for a critical-task, multiple VPA devices may be used together for notification and a back off time may be small with multiple retrials.

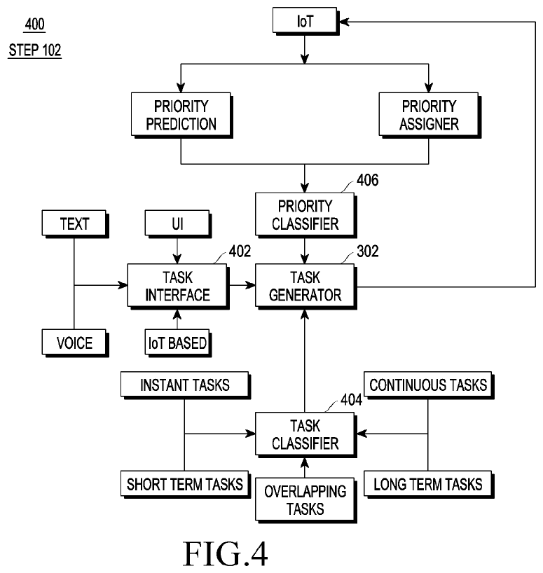

FIG. 4 illustrates a structure of task generator 302 of FIG. 3 in accordance with an embodiment of the present disclosure. The task generator 302 may collect all the information about the task received from the user and may send the information to the device and notification scheduler as later depicted in FIG. 5.

The task generator 302 may include a task interface 402 that renders different ways, a user can assign the task to the VPA. The task interface 402 may include giving instructions to the VPA device to delegate task to other device. Modes can be a voice command, a text command, a UI based option selection, etc.

The task generator 302 may further include a task-classifier 404 for classifying the task depending on the type of the task user has given. Long term tasks may include emergency cases like a fire, and an accident. Short term tasks may include tasks for short period of time like scheduling an appointment, a baby cry, and flight reminders. Continuous tasks may include cases that human intervention is needed after some period of time like baking a cake in an oven. Instant tasks may include queries from the VPA, playing music, setting an alarm, calling a friend. Overlapping tasks may include all those tasks that are happening simultaneously and the VPA device may provide the response to the user depending on the priority of the tasks.

The task classifier 404 overall may be summarized as follows:

| | |
|---|---|
| Input: | a text command, operating state of the |
| | device, and a preference of the user |
| Output: | long term task, short term task, |
| | continuous task, and overlapping and instant |
| | task |
| Training phase | Naïve Bayes or Random Forest based |
| | DNN model can be trained with word |
| | embeddings from command as input along |
| | with user's preference and device's operating |
| | state as encoded values. Labels for task types |
| | are added in training data such as long term, |
| | short term, instant, continuous, overlapping |
| | etc. |
| Runtime: | At runtime, trained model will take |
| | input parameters of user's command as text, |
| | device operating state and user preferences to |
| | predict the most probable task category under |
| | given circumstances as it's result. |

The task generator 302 may further include a priority classifier 406 that may be a machine learning/reinforcement learning based model that may assign the priority to the task, an example accident over a reminder, a fire alarm over a flight reminder. This model may keep on learning over time depending on a preference of a user. The priority classifier 406 may include:

a) Priority Prediction: may check the task information and may predict the priority of the same depending on scheduled as well as executing tasks.

b) Priority Assigner: may assign the priority to the task and may send the information to the task generator 302.

The priority classifier 406 may have three different modes depending on the priority as follows.

a) Critical Mode: This mode may have the highest priority. The back off time of this mode may be very low. The user may get the response on multiple devices together in this mode.

b) High Mode: This mode may have moderate priority and can include important tasks. In this mode, a back off time may be higher than critical mode and a response may be sent to one device at a time.

c) Normal Mode: This mode may have the least priority and the back off time for this mode may be high. In this mode, the task may be suspended without even an acknowledgement after two or three attempts of the acknowledgement.

The priority classifier 406 overall may be summarized as follows:

| | |
|---|---|
| Input: | Text command, Device's operating state, |
| | User's preference |
| Output: | Critical, Major, Normal |
| Training phase | Random Forest based DNN model can be |
| | trained with word embeddings from command |
| | as input along with user's preference and |
| | device's operating state as encoded values. |
| | Labels for task types are added in training data |
| | such as critical, major, normal etc. |
| Runtime: | At runtime, trained model will predict the |
| | most probable task category under given |
| | circumstances as it's result. Using |
| | reinforcement learning, the model will |
| | consider user input and learn over the time to |
| | understand behaviour. |

FIG. 5 illustrates the process of task validation in accordance with another embodiment of the present disclosure. FIG. 5 may correspond to step 102 of FIG. 1.

Referring to FIG. 5, based on a voice-command of the user, a text command, or an event-based trigger, a NLP 502 system may generate at least one task. As a task validator 504 has access to Task DB 303 of FIG. 3, the task validator 504 may accordingly check and validate the at least one generated task. If the at least one generated task is not found, then regular execution may take place.

If the at least one generated task is found in the task DB 303 of FIG. 3, then the task validator 504 may provide the task information such as a priority-level of the at least one generated task, a type of the at least one generated task, preferences to a device and notification scheduler 506, which is later elaborated in FIG. 6. The task validator 504 may accordingly act as an initializer only when a user has a genuine request, otherwise the task validator 504 may not trigger a system.

FIG. 6 illustrates a structure of device and notification scheduler 506 in accordance with an embodiment of the present disclosure. FIG. 6 may correspond to the step 104 and 106 of FIG. 1.

The structure of device and notification scheduler 506 may comprise a cloud server or a remote server that may be edge based, onDevice based, or cloud-based service which can help in getting device operating states and capabilities. In an example, a server may be a smart things service server 602. The smart things service server 602 may contain the information of the users and all their devices. The information may include recently active devices, active devices, device modes such as VPA supported, UI device, location of the device in home, etc. This information is used by the device and notification scheduler 506, to decide the device, mode and back-off time. As an example, if a speaker is playing music or a TV is playing, then a user is evidently using it. If wearable device is not active, then user is not wearing it etc.

The structure of device and notification scheduler 506 may further comprise a device preference module 604 wherein a user can set preferred device based on task. The device preference module 604 may dynamically store the user preference by logging user interaction and activity in real-time. Example is for emergency SOS cases use mobile call, for fire alarms in home use speaker for playing message loud, for simple tasks like inform when 10 k steps are done, reminder for meeting use wearable notification etc.

The structure of device and notification scheduler 506 may further comprise a device preference analyser 606 which may compute a preference of the user towards a particular device post task completion and whether or not user successfully acknowledges the device response. The device preference analyser 606 may use device preference information, user preference and user activity detection, and may give a list of the preferred device to the device and notification scheduler 506.

The device preference analyser 606 may analyze a user preference. For many tasks a target user/users (himself and others) can be set, such as example, “notify my wife when I reach office”, “inform urgently my mom, dad & wife if my accident happens”, “inform me when cake is baked”, etc. If target user is disabled person, then the devices for event notification can be decided based on user, for blind person voice response are preferred. For deaf person UI based notifications are preferred.

The device preference analyser 606 may further analyse a user activity detection. a current activity of the user may help in determining best mode of notification. If a GPS location of the user is outside a home, a mobile phone, and/or a wearable device may be used as a first preference. If user is in office, a mobile phone, a wearable device, and/or an office device, such as laptop, is used for informing user. If user is at home, a location of the user may be detected by states of the operating device, for example, TV playing, music, AC in bedroom, etc., along with intelligence such as a last voice command of the user to VPA devices, a mobile phone of the user, wearable device usage, etc. An example user activity detection may be referred as follows:

Mobile Call: 0.6

Mobile Message: 0.2

TV Popup: 0.1

Wearable Vibration: 0.09

Speaker Fire Sound: 0.01

The device and notification scheduler 506 may consider a priority-level of the task, a type of the task along with preferred device lists from device preference analyser 606 and the IoT device states as input. As output, the device and notification scheduler 506 may create a list of modes by which target user/users can be notified. Each mode may have a back-off timer and a possible acknowledgment reception mode, by which it can decide if user has successfully acknowledged the response or not. In an example, for a mode such as a mobile call, a back-off time is selected as 30 Seconds.

FIG. 7 illustrates an extended structure of FIG. 6 comprising a device and notification scheduler 506, a task termination flag generator 702, and an event notification 704 with back-off timer in accordance with an embodiment of the present disclosure. FIG. 7 may correspond to the step 108.

The device and notification scheduler 506 may have a list of modes by which user can be informed. Using IoT device states from the smart things, the probability of each mode may be updated. For example, if some devices are offline, they may be removed, if some devices are not active, they may be assigned a lower probability, if some devices are recently used or are active, they may be assigned a higher probability. After all, the list of the final mode list may be prepared. The device and notification scheduler 506 may pick up the most preferred mode and may send the event notification to the devices of the user.

A task termination flag generator 702 may set a task termination flag to active or inactive: If a task has been completed or has been notified to a user but has not been acknowledged by the user multiple times, then the task might be terminated subject to nature of the task. If a user acknowledges, then the flag may be set to inactive, and no further event notifications may send to user.

For a critical task, until an acknowledgement from a user is received, a flag may not be reset to inactive, for example emergency SOS tasks. For normal tasks, if a user does not acknowledge in two or three event notifications, then the flag may be set to inactive, and no further event may be sent, thereby not to annoy users. At least an advantage of this flag is that it may help to make sure that the intended user receives the event notification. As example for critical tasks, the modes may be calculated, and multiple event notifications may be sent using one or more than one devices, until acknowledgement is received.

Overall, the flag may be set to inactive upon receipt of an acknowledgement from user, an elapse of a dynamically-configured time, and an occurrence of number of attempts of communication of the task execution status.

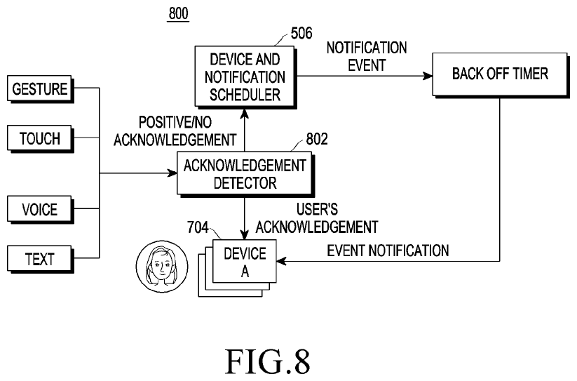

A back-off time may be defined by computing a period of said repetition of said communication based on the priority-level of the task, a nature of the task and VPA device employed for communicating the task, said period representing a time of awaiting acknowledgement from the user in response to the communication of the task execution status to the user. The back-off time may represent the time for which an acknowledgement detector (referred in FIG. 8) waits for response from user. The back-off time may depend upon nature of task, VPA device it is allotted to and the priority-level of the task. As example for critical tasks, the back-off time may be less, so that next set of event notification may be tried, and a user may be acknowledged. For normal tasks, a back-off time may be long. For VPA devices with audio playback event notification such as a speaker, the back-off time may be less, as after an audio response, a user should acknowledge immediately. VPA devices with UI based event notification such as mobile phones, TVs, etc., the back-off time may be more, as the user can see the event for longer time. The back off time may be computed by the event notification 704.

FIG. 8 illustrates an extended structure of FIG. 7 comprising an acknowledgement detector 802 in accordance with another embodiment of the present disclosure.

The acknowledgement detector 802 may await the acknowledgement from the user until an elapse of the computed period and may repeat said communication of the task execution status by resorting to a different mode of the communication in case of no acknowledgement from the user. The acknowledgement detector 802 may enable the task termination flag as inactive to discontinue further communication upon receipt of acknowledgement. The user acknowledgement of the task execution status may be received through one or more of a voice response, a gesture, a UI interaction, etc.

Once the event notification is sent to a device of the user, the event may be shown as notification in UI based devices, and an audio response may be played in VPA devices. A call may be made to a mobile phone, and a message may be sent to user on the app where user is last active.

The user may acknowledge the response in any of the below manners:

User may reply “Hi, Thank you”, “Hi, Ok I will check”, “Hi, I will take necessary action”, etc. An NLP system may tell if a user has acknowledged for the task or not. A user may acknowledge by clicking UI options from notification/popup, etc., by sliding the notification, or by clicking an Ok button. A user may acknowledge by a text command if the event was received by messaging. A user may acknowledge the event by a gesture such as a thumbs up, nodding of a head, etc. These may be detected by a camera.

The acknowledgement detector 802 may await detection till expiration of a back-off timer. If the user does not acknowledge in this time, then the acknowledgement detector 802 may inform the device and notification scheduler 506 to update the modes list, and may start a next set of event notification. If the acknowledgement detector 802 detects the acknowledgement of the user, then the acknowledgement detector 802 may inform the device and notification scheduler 506 to set the task termination flag, and may stop sending further event notifications.

The device and notification scheduler 506 overall may be summarized as follows:

| | |
|---|---|
| Input: | Task Classifier output, Priority Classifier |
| | output, Device's operating states using smart |
| | things, User preference |
| Output: | List of response modes with one or more |
| | devices control |
| Training phase | Random Forest based multi label |
| | classification DNN model can be trained with |
| | labelled input the training data created on IoT |
| | devices capability list with output modes as |
| | response labels. |
| Runtime: | At runtime, trained model will take task |
| | classifier, priority classifier output, smart |
| | things device operating states and user |
| | preference as input and predict a list of modes |
| | by which user can be informed. Each mode |
| | will have a favourable probability, based on |
| | probability the list is sorted, and most |
| | favourable mode is used to inform user. |

A back-off time analyzer overall may be summarized as follows:

| | |
|---|---|
| Input: | Device and Notification Scheduler output list, |
| | User preference |
| Output: | Time in seconds |
| Training phase | DNN regression model can be trained to |
| | predict time for which assistant should wait |
| | for user acknowledgement. Training data will |
| | consist of time range labels inferred from real |
| | usage scenarios. |
| Runtime: | At runtime, trained model will predict the |
| | back-off time for each of the response mode |
| | generated by device and notification scheduler |
| | module. |

An acknowledgement detector 802 overall may be summarized as follows:

| | |
|---|---|
| Input: | User output in term of gesture through |
| | different modes of touch, gesture, text and |
| | voice. |
| Output: | Response in Yes if user has acknowledged or |
| | No if user has not acknowledged. |
| Training phase | Logistic Regression based Binary |
| | classification DNN model will be trained |
| | using real usage Scenarios of voice, text and |
| | gesture. |
| Runtime: | At runtime, trained model will take user |
| | output, within the back off time, as input and |
| | predict if user has acknowledged the response |
| | in any mode. |

Overall, the present disclosure in light of preceding description may be summarized as follows:

a) A task may be assigned to the VPA through task interface 402.

b) The task classifier 404 may classify the task to a sub category.

c) The priority classifier 406 may assign a priority to the task depending on which other tasks are already performing by the VPA and which tasks are scheduled for later time.

d) An event has been assigned to a particular VPA according to a user device preference based on the device preference analyser 604.

e) The VPA device through the device and notification scheduler 506 may process the task and may provide a response to the user and may wait for a back-off time to get acknowledged.

f) An acknowledgement may be received by an acknowledgement detector 802, the VPA may end the task.

g) In case that the acknowledgement is not received by an acknowledgement detector 802, the VPA device may send the information to the device and notification scheduler 506.

h) The device and notification scheduler 506 may indicate that the acknowledgement is not received and the acknowledgement is pending.

i) The device and notification scheduler 506 may collect the information from a cloud service and pass through the task termination flag generator 702.

j) The task termination flag generator 702 may check if the flag is true.

k) The task termination flag generator 702 may use the task preference, task type and may use machine learning to decide whether to continue sending the information to the user through different ways or end the task.

l) In case that the task termination flag is true, then the device and notification scheduler 506 may tell the VPA to end the task.

m) In case that the task termination flag is false, the device and notification scheduler 506 may check the device preference and may assign another or same device to provide the response to the user.

n) There may be various ways for the VPA to provide the response. Popping the message on the TV when user is watching, voice or popup notification to wearable or phone, text message to the user etc.

o) User may use voice, text or touch/click depending on his comfort to provide acknowledgement. User may use phrase like “Thanks”, “Ok” and “ I will take care”.

p) The acknowledgement detector 802 may detect the user response through various modes for a back-off time and may send the information to the device.

q) The same procedure may be used till the task termination flag is true or acknowledgement is not received.

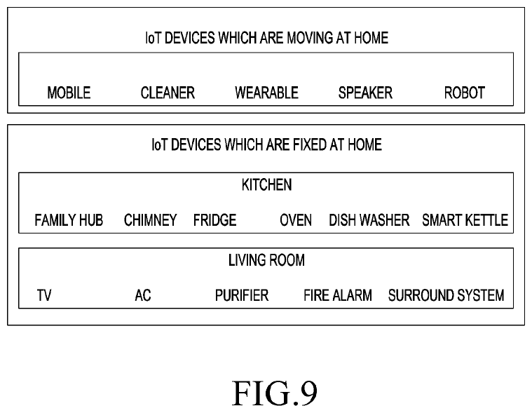

FIG. 9 illustrates a list of IOT devices in accordance with another embodiment of the present disclosure. FIG. 9 may correspond to an example scenario depicting a user presence/activity detection for device selection and user location.

In case 1 when the user is not at home, then using the GPS, a user location may be known as out of home, travelling, roaming, in office etc. Devices such as a mobile phone, a watch, galaxy buds, etc. may be preferred for event notification.

In case 2, when the user is at home, then as shown in FIG. 9, home devices may be categorized as fixed and moving. If a current/most recent interaction of the user is with a fixed device, then the room of that device can be identified.

In addition, identification of supported IOT devices may be performed from a remote server or cloud service. It may help in getting device lists and capabilities for event notification.

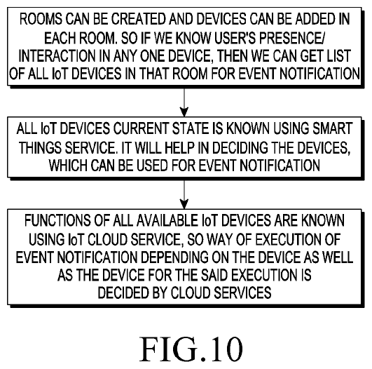

FIG. 10 illustrate a procedure for a user location detection and event notification with help of a remote server service in accordance with another embodiment of the present disclosure.

A cloud service or remote server-based service, such as smart things, may be used to get all the information of the devices with their room wise location. The same may provide the current or last user interaction with a device and may give more priority to devices of that room. Cloud service may know the device operating states whether in idle, working or shut down mode that would be used for a priority assignment of the devices.

Cloud service control may know all the functions of the devices so it may be used to notify the user about the event with most favorable mode of the device. IOT devices may be categorized as dynamic and fixed devices. Dynamic/moving devices may include a mobile phone, a wearable device, a cleaner, a robot etc. Fixed/static devices may include a TV, a washing machine, a family hub, a fridge, a microwave etc. Using the GPS of the moving devices, through cloud service, user's location may be identified. A user location may be useful to prioritize the devices for the event notification. If the user is not at home, then fixed devices may be given a very low priority. If the user is at home, then using smart things service, the location of the device with which user recently interacted or currently interacting may be found.

If the device is a fixed device, then cloud may identify the particular room where the device is placed and all the devices within the room. These devices may get high priority and the event may be notified to the user with device's favorable mode. If the device is a dynamic device, then these devices may get a higher priority and the event may be notified.

Using the cloud service, we can know if home devices have systems like visual intelligence (security camera etc.) and aural/acoustic scene intelligence (User's presence identification based on audio by Speaker etc.) that can be used for determining the user location, and to provide higher priority to the device in that room.

The forthcoming description refers the use cases in tabular format as follows:

Following Table 1 and 2 depicts example decision making parameters with respect to step 112 of FIG. 1.

TABLE 1

| | | | Device | | | |
|---|---|---|---|---|---|---|
| | Task | Priority | Preference | Notification | Back off | Acknowledgement |
| Use Case | Classifier | Classifier | Analyzer | Scheduler | Time | Module |
| Emergency | Long Term | Critical | 1. Mobile | Notification | 10 seconds | Text |
| Accident | | | 2. Lux | Mode 1 | | |
| Slide 29 1st | | | 3. Wearable | Mobile: 0.8 | | |
| Notification | | | 4. TV | (user is | | |
| | | | | currently | | |
| | | | | using | | |
| | | | | phone) | | |
| Emergency | Long Term | Critical | 1. Wearable | Notification | 10 seconds | Voice |
| Accident | | | 2. Mobile | Mode 2 | | |
| Slide 29 | | | 3. TV | Wearable: | | |
| 2nd | | | 4. Lux | 0.65 (As | | |
| Notification | | | | user has | | |
| | | | | worn the | | |
| | | | | watch) | | |
| Normal | Continuous | Normal | 1. Washing | Notification | 2 min | Voice/Touch |
| Task | | | Machine | Mode 1 | | |
| Slide 35 | | | 2. Lux | Washing | | |
| 1st | | | 3. Mobile | Machine: | | |
| Notification | | | 4. Wearable | 0.8 (User | | |
| | | | 5. Lux | has assigned | | |
| | | | | to Washing | | |
| | | | | Machine) | | |
| Normal | Continuous | Normal | 1. Lux | Notification | 2 min | Voice |
| Task | | | 2. Mobile | Mode 2 | | |
| Slide 35 | | | 3. Washing | Lux: 0.50 | | |
| 2nd | | | Machine | Mobile: | | |
| notification | | | 4. Wearable | 0.40 (User | | |
| | | | 5. Lux | preferences) | | |

TABLE 2

| | | | Device | | | |
|---|---|---|---|---|---|---|
| | Task | Priority | Preference | Notification | Back off | Acknowledgement |
| Use Case | Classifier | Classifier | Analyzer | Scheduler | Time | Module |
| Normal | Continuous | Normal | 1. Mobile | Notification | 2 min | Voice/Gesture |
| Task | | | 2. Lux | Mode 3 | | |
| Slide 35 | | | 3. Washing | Mobile: | | |
| 3rd | | | Machine | 0.60 (user | | |
| Notification | | | 4. Wearable | preferences) | | |
| | | | 5. Lux | | | |
| Child wake | Short | High | 1. Lux | Notification | 30 seconds | Voice |
| up scenario | Term | | 2. Wearable | Mode 1 | | |
| Slide 31 1st | | | 3. Mobile | Speaker | | |
| Notification | | | 4. TV | Playback: | | |
| | | | | 0.8 (User | | |
| | | | | has assigned | | |
| | | | | the task to | | |
| | | | | Lux) | | |
| Child wake | Short | High | 1. Mobile | Notification | 30 seconds | Voice |
| up scenario | Term | | 2. TV | Mode 2 | | |
| Slide 31 | | | 3. Wearable | Mobile | | |
| 2nd | | | 4. Lux | Popup: 0.6 | | |
| Notification | | | | (User has | | |
| | | | | assigned to | | |
| | | | | the task to | | |
| | | | | phone) | | |
| Child wake | Short | High | 1. TV | Notification | 30 seconds | Gesture and Voice |
| up scenario | Term | | 2. Mobile | Mode 3 | | |
| Slide 31 | | | 3. Wearable | TV popup: | | |
| 3rd | | | 4. Lux | 0.40 | | |
| Notification | | | | Mobile | | |
| | | | | popup: 0.40 | | |
| | | | | (User is | | |
| | | | | watching | | |
| | | | | TV and | | |
| | | | | mobile | | |
| | | | | device is | | |
| | | | | nearby) | | |

Following Table 3 depicts scenarios and use cases for task generation with respect to FIG. 3 and FIG. 4.

TABLE 3

| Task | | Task | |
|---|---|---|---|
| Priority | Use Cases | Type | Use Cases |
| Critical | “Inform mom, dad and | Long | “Inform mom, dad and |
| | wife if I say help me 3 | Term | wife if I say help me 3 |
| | times” | Task | times.” |
| | “Inform all member of | | “Set a reminder for |
| | home on priority | | exercise at 6 AM every |
| | whenever a fire is | | morning” |
| | detected” | | |
| Major | “Inform me when the | Short | “Inform me when the |
| | baby wakes up.” | Term | washing of clothes is |
| | “Remind me for my | Task | completed.” |
| | meeting with X at 3 PM.” | | “Inform me when the |
| | | | child wakes up.” |
| Normal | “Inform me when clothes | Contin- | “Snooze the alarm for |
| | in washing machine are | uous | ten minutes.” |
| | done” | Task | “Inform me status of |
| | “Remind me to buy | | cake in over after ever |
| | groceries at 6 PM | | two minute.” |
| | | Instant | “Play song X on lux |
| | | Task | speaker.” |
| | | | “Give me weather |
| | | | update.” |

Following Table 4 depicts scenarios and use cases based on device preference and IoT device's operating states with respect to FIG. 6.

TABLE 4

| IoT | | Device | |
|---|---|---|---|
| Device | Use cases of event | Prefer- | Use cases of event |
| State | notification mode | ence | notification mode |
| Some | Device state: TV | 1 pre- | User is in office and the |
| devices | (unresponsive/off), | ferred | notification in form of text |
| are off/ | Lux (active), mobile | device | or mobile (only preferred |
| unre- | (active), wearable | | device) device “Child has |
| sponsive | (unresponsive/off) | | reached home.” |
| | Notification on Lux | | User is having wearable |
| | “Child has woken up” | | (only preferred device) and |
| | Notification on mobile | | is exercising, notification in |
| | “Reminder for buying | | form of UI |
| | groceries” | | “meeting with X at 8 AM” |
| All | Device state: TV | More | User preference: (Mobile, |
| device's | (active), Lux (active), | than | TV, Wearable, Lux . . . ) |
| active | mobile (active), | 1 pre- | If state of TV is active an no |
| | wearable (active) | ferred | acknowledgement received |
| | Notification on TV | device | on mobile than send the |
| | with message “Child | | notification to TV. |
| | has woken up.” | | |
| | Notification on | | |
| | wearable “Reminder | | |
| | for gym” | | |
| | Notification on TV | | |
| | “Baking is | | |
| | completed” | | |

Following Table 5 depicts scenarios and use cases based on user activity and user's preference with respect to FIG. 6.

TABLE 5

| User | Use cases of event | User | Use cases of event |
|---|---|---|---|
| Activity | notification mode | Preference | notification mode |
| user in | Notification using | For user | “remind me when the |
| home | voice mode such | himself/ | cake is baked” |
| | as on Lux or | herself | “Wash the cloths and |
| | mobile | | inform me for any issue” |
| | | | “Tell me when child |
| | | | wake up”; etc. |
| User in | Notification using | For other | “Inform my wife when |
| Office | UI mode such | single | I reach office” |
| | device notification | person | “Wake up my kid at |
| | or text on mobile | | 7 AM tomorrow”. |
| | device | | |
| User | Notification using | For other | “Tell my parents and |
| outside, | UI/voice mode on | multiple | siblings if I call help |
| cycling, | wearable, mobile | persons | me thrice” “Share the |
| swimming, | | | location to my parents, |
| roaming, | | | when I command |
| etc | | | Emergency” |

Following example Table 6 depicts scenarios and use cases based on user acknowledgement with respect to FIG. 8.

TABLE 6

| Event | | Event | |
|---|---|---|---|
| Notifi- | | Notifi- | |
| cation | Use cases | cations | Use cases |
| Single | One device at a time, | Voice | “Hi Bixby, OK” |
| device | example to remind | response | “Hi, Bixby, Thank you” |
| | meeting schedule on | | “Hi Bixby, Got you” |
| | mobile, remind to take | | “Hi Bixby, tanks for |
| | steps on earbuds, task | | informing” |
| | completion, message | | “Hi Bixby, I will take |
| | from washing machine | | case”, etc. |
| | or microwave, etc. | | Useful for all Bixby |
| | | | devices |
| Multiple | In case of critical task, | Gesture | Gestures such as nodding |
| devices | response to user by | response | the head for yes, waving |
| | multiple devices in | | the hand for camera, |
| | parallel: as example on | | wearable based gestures, |
| | accident, call to father, | | etc. (Helps more in case |
| | play message on Bixby | | of disabled person). |
| | based device of wife | | |
| | along with call and | | |
| | message | UI based | Message reply such as |
| | | response | “OK”, “Thanks”, |
| | | | “Got it”, etc. |
| | | | Notification panel swipe |
| | | | or clicking OK. |
| | | | On TV popup click OK |
| | | | by remote, etc. |

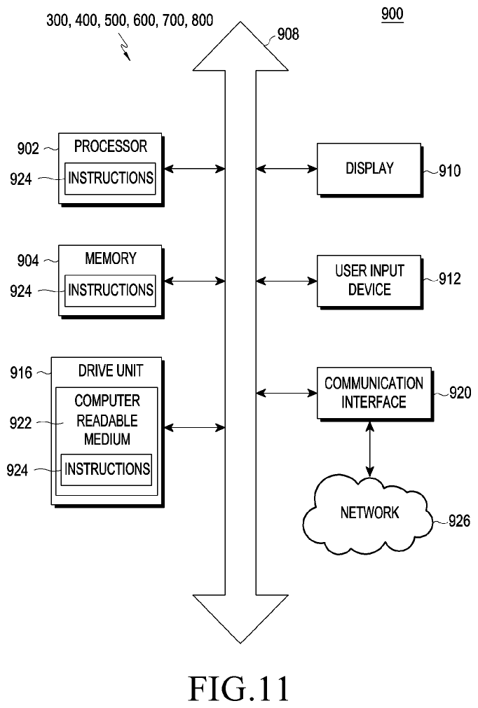

FIG. 11 illustrates a typical hardware configuration of the system 200, in the form of a computer-system 900, in accordance with another embodiment of the present disclosure. The computer system 900 may include a set of instructions that can be executed to cause the computer system 900 to perform any one or more of the methods disclosed. The computer system 900 may operate as a standalone-device or may be connected, e.g., using a network, to other computer systems or peripheral devices.

In a networked deployment, the computer system 900 may operate in the capacity of a server or as a client user computer in a server-client user network environment, or as a peer computer system in a peer-to-peer (or distributed) network environment. The computer system 900 may also be implemented as or incorporated across various devices, such as a personal computer (PC), a tablet PC, a personal digital assistant (PDA), a mobile device, a palmtop computer, a laptop computer, a desktop computer, a communications device, a wireless telephone, a land-line telephone, a web appliance or any other machine capable of executing a set of instructions (sequential or otherwise) that specify actions to be taken by that machine. Further, while a single computer system 900 is illustrated, the term “system” shall also be taken to include any collection of systems or sub-systems that individually or jointly execute a set, or multiple sets, of instructions to perform one or more computer functions.

The computer system 900 may include a processor 902 e.g., a central processing unit (CPU), a graphics processing unit (GPU), or both. The processor 902 may be a component in a variety of systems. For example, the processor 902 may be part of a standard personal computer or a workstation. The processor 902 may be one or more general processors, digital signal processors, application specific integrated circuits, field programmable gate arrays, servers, networks, digital circuits, analog circuits, combinations thereof, or other now known or later developed devices for analyzing and processing data. The processor 902 may implement a software program, such as code generated manually (i.e., programmed).

The computer system 900 may include a memory 904, such as a memory 904 that can communicate via a bus 908. The memory 904 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one example, the memory 904 includes a cache or random access memory for the processor 902. In alternative examples, the memory 904 is separate from the processor 902, such as a cache memory of a processor, the system memory, or other memory. The memory 904 may be an external storage device or database for storing data. The memory 904 is operable to store instructions executable by the processor 902. The functions, acts or tasks illustrated in the figures or described may be performed by the programmed processor 902 for executing the instructions stored in the memory 904. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 900 may or may not further include a display unit 910, such as a liquid crystal display (LCD), an organic light emitting diode (OLED), a flat panel display, a solid state display, a cathode ray tube (CRT), a projector, a printer or other now known or later developed display device for outputting determined information. The display 910 may act as an interface for the user to see the functioning of the processor 902, or specifically as an interface with the software stored in the memory 904 or in the drive unit 916.

Additionally, the computer system 900 may include an input device 912 configured to allow a user to interact with any of the components of system 900. The computer system 900 may also include a disk or optical drive unit 916. The disk drive unit 916 may include a computer-readable medium 922 in which one or more sets of instructions 924, e.g. software, can be embedded. Further, the instructions 924 may embody one or more of the methods or logic as described. In a particular example, the instructions 924 may reside completely, or at least partially, within the memory 904 or within the processor 902 during execution by the computer system 900.

The present disclosure contemplates a computer-readable medium that may include instructions 924 or may receive and execute instructions 924 responsive to a propagated signal so that a device connected to a network 926 may communicate voice, video, audio, images or any other data over the network 926. Further, the instructions 924 may be transmitted or received over the network 926 via a communication port or interface 920 or using a bus 908. The communication port or interface 920 may be a part of the processor 902 or may be a separate component. The communication port 920 may be created in software or may be a physical connection in hardware. The communication port 920 may be configured to connect with a network 926, external media, the display 910, or any other components in system 900, or combinations thereof. The connection with the network 926 may be a physical connection, such as a wired Ethernet connection or may be established wirelessly as discussed later. Likewise, the additional connections with other components of the system 900 may be physical connections or may be established wirelessly. The network 926 may alternatively be directly connected to the bus 908.

Further, at-least one of the plurality of modules of mesh network may be implemented through AI based on an ML/NLP logic A function associated with AI may be performed through the non-volatile memory, the volatile memory, and the processor constituting the first hardware module i.e. specialized hardware for ML/NLP based mechanisms. The processor may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The aforesaid processors collectively correspond to the processor.

The one or a plurality of processors control the processing of the input data in accordance with a predefined operating rule or artificial intelligence (AI) model stored in the non-volatile memory and the volatile memory. The predefined operating rule or artificial intelligence model is provided through training or learning.

Here, being provided through learning means that, by applying a learning logic/technique to a plurality of learning data, a predefined operating rule or AI model of the desired characteristic is made. “Obtained by training” means that a predefined operation rule or artificial intelligence model configured to perform a desired feature (or purpose) is obtained by training a basic artificial intelligence model with multiple pieces of training data by a training technique. The learning may be performed in a device itself in which AI according to an embodiment is performed, and/or may be implemented through a separate server/system.”

The AI model may consist of a plurality of neural network layers. Each layer has a plurality of weight values, and performs a neural network layer operation through calculation between a result of computation of a previous-layer and an operation of a plurality of weights. Examples of neural-networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The ML/NLP logic is a method for training a predetermined target device (for example, a robot) using a plurality of learning data to cause, allow, or control the target device to make a determination or prediction. Examples of learning techniques include, but are not limited to, supervised learning, unsupervised learning, semi-supervised learning, or reinforcement learning.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to the problem and any component(s) that may cause any benefit, advantage, or solution to occur or become more pronounced are not to be construed as a critical, required, or essential feature or component of any or all the claims.

Although the present disclosure has been described with various embodiments, various changes and modifications may be suggested to one skilled in the art. It is intended that the present disclosure encompass such changes and modifications as fall within the scope of the appended claims.

What is claimed is:

1. A method for executing tasks in an IoT environment using artificial-intelligence (AI) techniques, the method comprising:
receiving at least one current task related to a user;
identifying, based on a pre-defined criteria, a type of the at least one current task and a priority-level of the at least one current task from the at least one current task;
generating, based on an AI-model, a correlation of one or more of a user-location, a device-usage history pertaining to the user, a list of current active devices with respect to the user, and a user-preference within the IoT environment; and
identifying at least one device for communicating a task execution status based on the correlation and based on at least one of the type of the at least one current task and the priority-level of the at least one current task.

2. The method of claim 1, wherein identifying the at least one current task comprises:
receiving, in a historical past, at least one task from the user;
classifying the at least one task using the pre-defined criteria into at least one of a type of the at least one task and a priority-level of the at least one task; and
creating a repository of the at least one classified task to identify the at least one current task.

3. The method of claims 1, wherein the type of the at least one current task is defined by one or more of an instant term, a short term, a long term, a continuous term, and overlapping terms.

4. The method of claims 1, wherein:
the priority-level of the at least one current task is related to a time-duration of awaiting user-acknowledgment post communication of the task execution status, and
the time-duration is defined by one or more of:
a short time duration with one or more of a critical or a high level priority;
a mid-size time duration with a high level priority; and
a large time duration with a normal level priority.

5. The method of claim 1, wherein the at least one device is further identified based on one or more parameters including: a user location, a device-usage history, a device current operational status, and a user-preference.

6. The method of claim 3, wherein the type of the at least one current task is mapped with a priority-level of the at least one current task through at least one of:
a long term task with one or more of a critical level priority or a high level priority;
a short term task or instant task with one or more of a high level priority or a normal level priority; and
continuous and overlapping task with a high level priority or a normal level priority.

7. The method of claim 3, wherein the correlation of the device-usage history is based on computation of a device preference through capturing in real-time a user-interaction and an activity with respect to the at least one device.

8. The method of claim 3, wherein:
the correlation of one or more of includes the user-location and the list of current active devices with respect to the user, and
the user-preference comprises capturing one or more of:
a user preference submitted with respect to a particular device;
a current user activity detection through device-usage; and
a user preference computed towards a particular device computed post task completion.

9. The method as claimed in claim 3, wherein identifying the at least one device for communicating the task execution status comprises executing the steps of:
ascertaining a task-termination flag in an active state and based thereupon determining a pendency of acknowledgment from the user;
performing communication for the task execution status as a task notification based upon ascertaining the active state, wherein the communication is enabled through selecting a communication mode;
repeating the communication for the task execution status periodically, wherein the repeated communication being resorted through a different mode of the communication; and
setting the flag as inactive upon one or more of:
a receipt of an acknowledgement from a user;
an elapse of a dynamically-configured time; and
an occurrence of a number of attempts of communication of the task execution status.

10. The method of claim 9, further comprising:
computing a period of repetition of the communication based on the priority-level of the at least one current task, a nature of the at least one current task and the at least one device employed for communicating the at least one current task, the period representing a time of awaiting acknowledgement from the user in response to the communication for the task execution status to the user.

11. The method of claim 10, further comprising:
awaiting the acknowledgement from the user until an elapse of the period;
repeating the communication for the task execution status by resorting to a different mode of the communication in case of no acknowledgement from the user; and
enabling the task termination flag as inactive to discontinue further communication upon receipt of the acknowledgement.

12. A method for executing tasks in an IoT environment using artificial-intelligence (AI) techniques, the method comprising:
receiving at least one current task related to a user;
identifying, based on a pre-defined criteria, a type of the at least one current task and a priority-level of the at least one current task from the at least one current task;
generating based on an AI-model, a correlation of one or more of a user-location, a device-usage history, a device current operational status, and a user-preference within the IoT environment;
identifying a list of modes for communicating a task execution status based on one or more of the correlation based on at least one of the type of the at least one current task or the priority-level of the at least one current task;
providing the task execution status on a first device associated with the one or modes within the list of modes;
detecting a non-acknowledgement from the user in respect of the task execution status provided from the first device or the first set of the devices for a predefined time duration; and
providing the task execution status on a second device associated with the one or modes within the list of modes after the predefined time duration.

13. The method of claim 12, further comprising receiving a user acknowledgement of the task execution status through one or more of a voice response, a gesture, and a UI interaction.

14. A voice personal assistant (VPA) device for executing tasks in an IoT environment using artificial-intelligence (AI) techniques, the VPA device comprising:
a communication unit; and
a processor coupled to the communication unit, wherein the processor is configured to:
receive at least one current task related to a user;
identify, based on a pre-defined criteria, a type of the at least one current task and a priority-level of the at least one current task from the at least one current task;
generate based on an AI-model, a correlation of one or more of a user-location, a device-usage history pertaining to the user, a list of current active devices with respect to the user, and a user-preference within the IoT environment; and
identify at least one device for communicating a task execution status based on one or more of the correlation based on at least one of the type of the at least one current task or the priority-level of the at least one current task.

15. The VPA device of claim 14, wherein the processor is configured to:
receive, in a historical past, at least one task from the user;
classify the at least one task using the pre-defined criteria into at least one of a type of the at least one task and a priority-level of the at least one task; and
create a repository of the at least one classified task to identify the at least one current task.

16. The VPA device of claims 14, wherein the type of the at least one current task is defined by one or more of an instant term, a short term, a long term, a continuous term, and an overlapping terms.

17. The VPA device of claim 16, wherein:
the priority-level of the at least one current task is related to a time-duration of awaiting user-acknowledgment post communication of the task execution status, and
the time-duration is defined by one or more of:
a short time duration with one or more of a critical or a high level priority;
a mid-size time duration with a high level priority; and
a large time duration with a normal level priority.

18. The VPA device of claims 14, wherein the at least one device is further identified based on one or more parameters including: a user location, a device-usage history, a device current operational status, and a user-preference.

19. The VPA device of claim 16, wherein the type of the at least one current task is mapped with a priority-level of the at least one current task through at least one of:
a long term task with one or more of a critical or a high level priority;
a short term task or instant task with one or more of a high level priority or a normal level priority; and
a continuous and overlapping task with high level priority or a normal level priority.

20. The VPA device of claim 16, wherein the correlation of the device-usage history is based on computation of a device preference through capturing in real-time a user-interaction and an activity with respect to the at least one device.
